(19) United States
(12) Patent Application Publication
(10) Pub. No.: US 2017/0295733 A1
(43) Pub. Date: Oct. 19, 2017

(54) Plant Watering Collar

(71) Applicant: Dawn Williams, Sonoma, CA (US)

(72) Inventor: Dawn Williams, Sonoma, CA (US)

(21) Appl. No.: 15/130,615

(22) Filed: Apr. 15, 2016

(51) Int. Cl. A01G 29/00

(52) U.S. Cl. CPC A01G 29/00

(57) ABSTRACT

A plant watering collar for reducing wastage of water includes a panel that has a first end and a second end. The panel is resilient and elongated rectangularly shaped. A first connector is coupled to the panel proximate to the first end. A second connector is coupled to the panel proximate to the second end. The second connector is complementary to the first connector. The second connector is positioned to couple to the first connector such that the panel defines a ring. The panel is configured for positioning around a soil bed housing at least one plant. The first connector is positioned to couple to the second connector such that the ring is formed. A bottom edge of the panel is configured to insert into the soil bed. The ring is configured to retain water directed within a perimeter of the ring.

### BACKGROUND OF THE DISCLOSURE

### Field of the Disclosure

The disclosure relates to watering collars and more particularly pertains to a new watering collar for reducing wastage of water.

### Summary of the Disclosure

An embodiment of the disclosure meets the needs presented above by generally comprising a panel that has a first end and a second end. The panel is resilient and elongated rectangularly shaped. A first connector is coupled to the panel proximate to the first end. A second connector is coupled to the panel proximate to the second end. The second connector is complementary to the first connector. The second connector is positioned to couple to the first connector such that the panel defines a ring. The panel is configured for positioning around a soil bed housing at least one plant. The first connector is positioned to couple to the second connector such that the ring is formed. A bottom edge of the panel is configured to insert into the soil bed. The ring is configured to retain water directed within a perimeter of the ring.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of a plant watering collar according to an embodiment of the disclosure.

FIG. 2 is a side view of an embodiment of the disclosure.

FIG. 3 is a top view of an embodiment of the disclosure.

FIG. 4 is an in-use view of an embodiment of the disclosure.

FIG. 5 is a cross-sectional view of an embodiment of the disclosure.

### DESCRIPTION OF THE PREFERRED EMBODIMENT

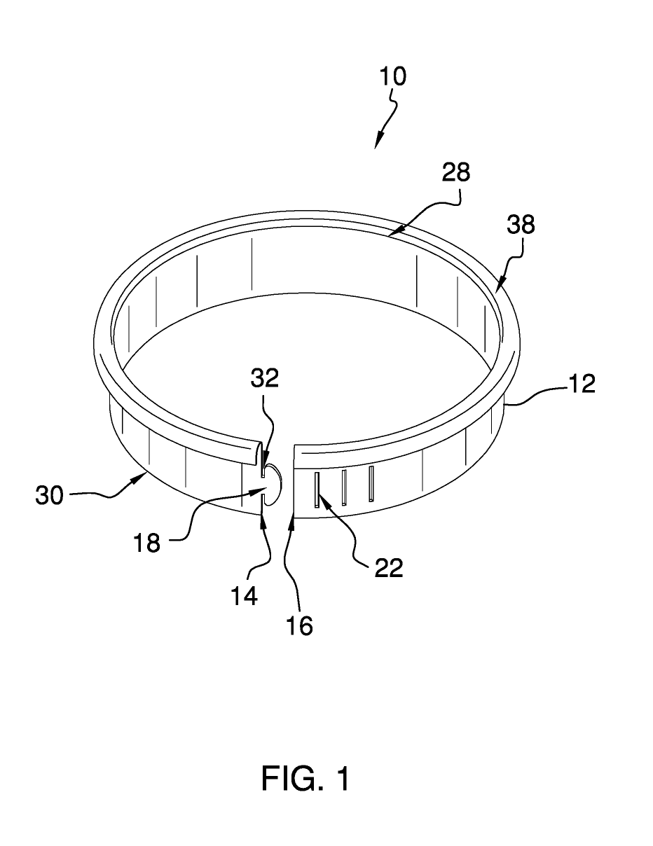

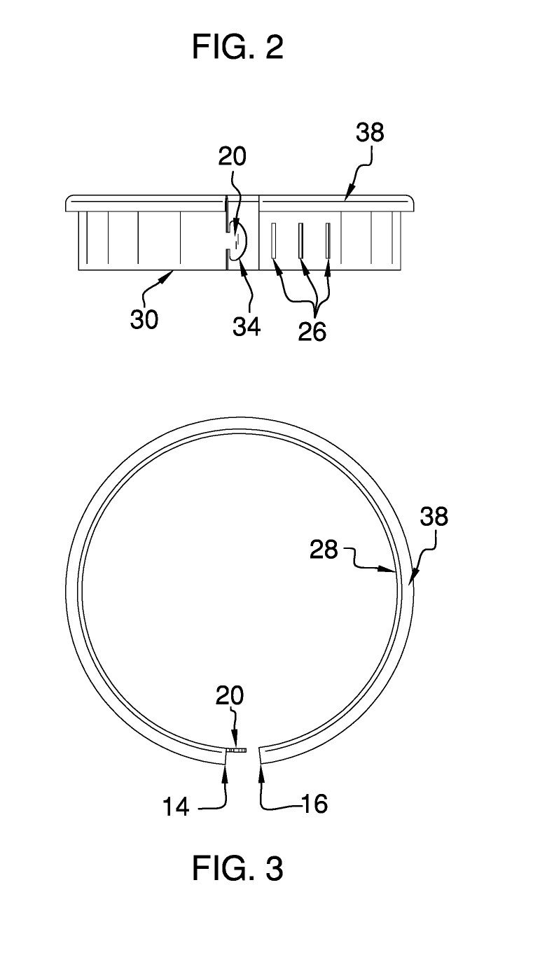

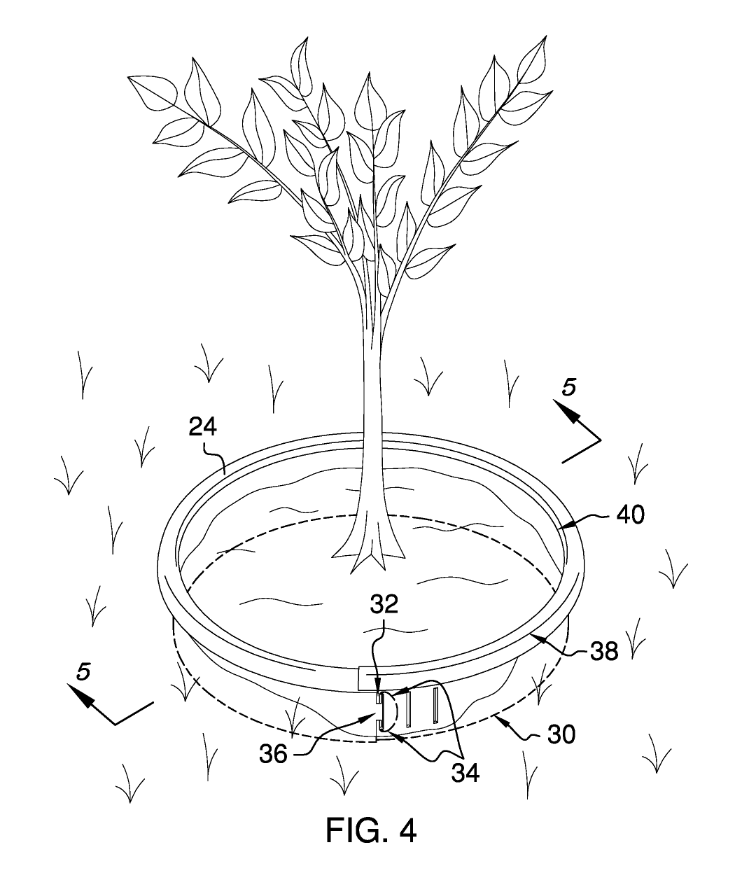

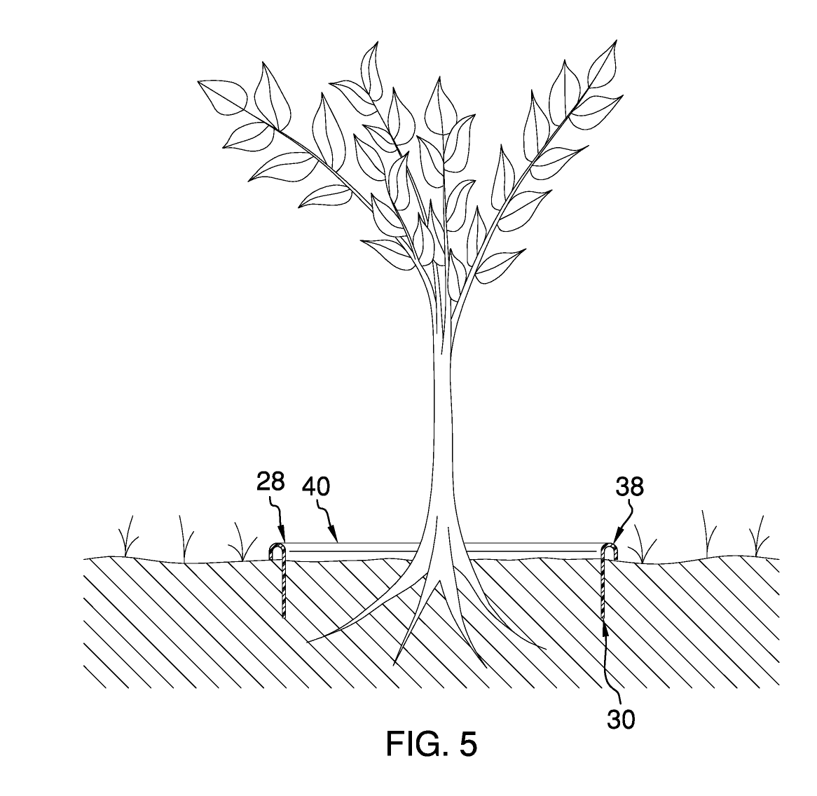

With reference now to the drawings, and in particular to FIGS. 1 through 5 thereof, a new watering collar embodying the principles and concepts of an embodiment of the disclosure and generally designated by the reference numeral 10 will be described.

As best illustrated in FIGS. 1 through 5, the plant watering collar 10 generally comprises a panel 12 that has a first end 14 and a second end 16. The panel 12 is resilient. The panel 12 is elongated rectangularly shaped.

A first connector 18 is coupled to the panel 12 proximate to the first end 14. The first connector 18 comprises a tab 20. The tab 20 extends coplanarly from the first end 14 of the panel 12. The tab 20 is arcuate.

A second connector 22 is coupled to the panel 12 proximate to the second end 16. The second connector 22 is complementary to the first connector 18. The second connector 22 is positioned to couple to the first connector 18 such that the panel 12 defines a ring 24. The ring 24 is substantially circularly shaped.

The second connector 22 comprises a plurality of slots 26. Each slot 26 is complementary to the tab 20. The slots 26 extend from proximate to a top edge 28 to proximate to a bottom edge 30 of the panel 12. The slots 26 are positioned in parallel. The slots 26 are substantially evenly spaced. The plurality of slots 26 comprises from one to five slots 26. The plurality of slots 26 comprises from two to four slots 26. The plurality of slots 26 comprises three slots 26.

Each of a pair of slits 32 is positioned in the tab 20 adjacent to the first end 14 of the panel 12. Each slit 32 extends from a respective opposing side 34 of the tab 20 defining a coupler 36. The coupler 36 is substantially equally positioned between the opposing sides 34 of the tab 20. The coupler 36 is positioned on the first end 14 of the panel 12 such that the tab 20 is configured for bending transverse to the panel 12, positioning the tab 20 for insertion in a respective slot 26.

A lip 38 is coupled to the top edge 28 of the panel 12. The lip 38 extends transversely from the panel 12. The lip 38 is positioned on the panel 12 such that the lip 38 is positioned to extend outwardly from the ring 24. The lip 38 is arcuate. The lip 38 extends from the top edge 28 toward the bottom edge 30 of the panel 12.

The present invention also anticipates coupling of two or more panels 12 to create a ring 24 having a larger diameter.

In use, panel 12 is configured for positioning around a soil bed housing at least one plant. The first connector 18 is positioned to couple to the second connector 22 such that the ring 24 is formed. The bottom edge 30 of the panel 12 is configured for insertion of into the soil bed. The ring 24 is configured to retain water directed within a perimeter 40 of the ring 24.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A plant watering collar comprising:
a panel having a first end and a second end, said panel being resilient, said panel being elongated rectangularly shaped;
a first connector coupled to said panel proximate to said first end;
a second connector coupled to said panel proximate to said second end, said second connector being complementary to said first connector, wherein said second connector is positioned to couple to said first connector such that said panel defines a ring; and
wherein said panel is configured for positioning around a soil bed housing at least one plant, such that said first connector is positioned to couple to said second connector wherein said ring is formed, such that a bottom edge of said panel is configured for insertion of into the soil bed, wherein said ring is configured to retain water directed within a perimeter of said ring.

2. The collar of claim 1, further including said ring being substantially circularly shaped.

3. The collar of claim 1, further comprising:
said first connector comprising a tab, said tab extending coplanarly from said first end of said panel; and
said second connector comprising a plurality of slots, each said slot being complementary to said tab.

4. The collar of claim 3, further including said tab being arcuate.

5. The collar of claim 3, further including said slots extending from proximate to a top edge to proximate to a bottom edge of said panel.

6. The collar of claim 3, further including said slots being positioned in parallel.

7. The collar of claim 3, further including said slots being substantially evenly spaced.

8. The collar of claim 3, further including said plurality of slots comprising from one to five said slots.

9. The collar of claim 8, further including said plurality of slots comprising from two to four said slots.

10. The collar of claim 7, further including said plurality of slots comprising three said slots.

11. The collar of claim 4, further including a pair of slits, each said slit being positioned in said tab adjacent to said first end of said panel, each said slit extending from a respective opposing side of said tab defining a coupler, wherein said coupler is positioned on said first end of said panel such that said tab is configured for bending transverse to said panel, such that said tab is positioned for insertion in a respective said slot.

12. The collar of claim 11, further including said coupler being substantially equally positioned between said opposing sides of said tab.

13. The collar of claim 1, further including a lip coupled to a top edge of said panel, said lip extending transversely from said panel, wherein said lip is positioned on said panel such that said lip is positioned to extend outwardly from said ring.

14. The collar of claim 13, further including said lip being arcuate.

15. The collar of claim 14, further including said lip extending from said top edge toward said bottom edge of said panel.

16. A plant watering collar comprising:
a panel having a first end and a second end, said panel being resilient, said panel being elongated rectangularly shaped;
a first connector coupled to said panel proximate to said first end, said first connector comprising a tab, said tab extending coplanarly from said first end of said panel, said tab being arcuate;
a second connector coupled to said panel proximate to said second end, said second connector being complementary to said first connector, wherein said second connector is positioned to couple to said first connector such that said panel defines a ring, said ring being substantially circularly shaped, said second connector comprising a plurality of slots, each said slot being complementary to said tab, said slots extending from proximate to a top edge to proximate to a bottom edge of said panel, said slots being positioned in parallel, said slots being substantially evenly spaced, said plurality of slots comprising from one to five said slots, said plurality of slots comprising from two to four said slots, said plurality of slots comprising three said slots;
a pair of slits, each said slit being positioned in said tab adjacent to said first end of said panel, each said slit extending from a respective opposing side of said tab defining a coupler, said coupler being substantially equally positioned between said opposing sides of said tab, wherein said coupler is positioned on said first end of said panel such that said tab is configured for bending transverse to said panel, such that said tab is positioned for insertion in a respective said slot;
a lip coupled to said top edge of said panel, said lip extending transversely from said panel, wherein said lip is positioned on said panel such that said lip is positioned to extend outwardly from said ring, said lip being arcuate, said lip extending from said top edge toward said bottom edge of said panel;
wherein said panel is configured for positioning around a soil bed housing at least one plant, such that said first connector is positioned to couple to said second connector wherein said ring is formed, such that a bottom edge of said panel is configured for insertion of into the soil bed, wherein said ring is configured to retain water directed within a perimeter of said ring.
